(19) United States
(12) Patent Application Publication
(10) Pub. No.: US 2016/0309712 A1
(43) Pub. Date: Oct. 27, 2016

(54) PREPARATION METHOD OF WATER SOLUBLE ANTIMICROBIAL POLYACRYLATE SILVER SALT

(71) Applicant: Shyhyeu Wang, Taoyuan City (TW)

(72) Inventor: Shyhyeu Wang, Taoyuan City (TW)

(21) Appl. No.: 15/095,149

(22) Filed: Apr. 10, 2016

(30) Foreign Application Priority Data
Apr. 21, 2015 (TW) 104112625

(51) Int. Cl. A01N 37/02

(52) U.S. Cl. CPC A01N 37/02

(57) ABSTRACT

Disclosed is a preparation method of water soluble antimicrobial polyacrylate silver salt. The water soluble antimicrobial polyacrylate silver salt is synthesized by dissolving a water soluble polyacrylate comprising sodium carboxylic group (—COONa) or potassium carboxylic group (—COOK) in water and then partially changing the sodium carboxylic group or potassium carboxylic group of the water soluble polyacrylate to silver carboxylic group (—COOAg) using silver salt in aqueous solution. Next, ultrafiltration membrane is used to remove the sodium salt or potassium salt generated from the metal ion exchanging procedure. The last step is to remove water from the ultrafiltration treated aqueous solution of polyacrylate silver salt to give water soluble antimicrobial polyacrylate silver salt.

### TECHNICAL FIELD

This invention is related to a preparation method of water soluble antimicrobial polyacrylate silver salt.

### BACKGROUND OF THE INVENTION

Bacteria have big influence on human's daily life. They affect human health and cause illness and death. So, it is very important to fight against bacteria. Until now, most of the antimicrobial agents fighting bacteria are small molecule chemicals. They are used in many applications such as anti-bacterial hygiene products, food preservative . . . etc. They can also be used as water or soil sterilization. Small molecule antibacterial agents have inherent problems such as residual toxicity to the environment, the short-term antimicrobial effect, easy to be absorbed by the human body . . . etc. One way to solve these problems is to use antimicrobial polymer instead of small molecule antimicrobial agent.

The use of antimicrobial polymers offers promise for enhancing the efficacy of some existing antimicrobial agents and minimizing the environmental problems accompanying conventional antimicrobial agents by reducing the residual toxicity of the agents, increasing their efficiency and selectivity, and prolonging the lifetime of the antimicrobial agents. (quoted from Biomacromolecules, 2007, vol. 8, No. 5, page 1359-1384)

Since many antimicrobial applications are in aqueous or hydrophilic environment, such as preservatives for cosmetic, antibacterial hand sanitizer, antibacterial cleansers . . . etc. So there is a need for developing water-soluble antibacterial polymer.

Since ancient times, the antimicrobial effect of silver is well known and applied by human in their daily life. In early times, people made food container from silver because they found out that food or milk in silver container were preserved longer than in other kind of containers.

Till modern time, silver for antimicrobial application has extended to different form such as silver ion and nano silver.

The antimicrobial silver ion is mostly existed in the form of salt such as silver nitrate, silver acetate, silver perchlorate, silver chlorate, and silver thiosulfate. Other than silver nitrate, silver acetate, silver perchlorate and silver chlorate, most of the salts of silver ion have low solubility in water.

Silver ion can also form complex with organic molecule. The most famous one is silver sulfadiazine. It is widely used in treating burning wound. However, silver sulfadiazine, like most of the silver salt, has low solubility in water.

In order to obtain water soluble organic silver salt, the organic molecule used to complex with silver ion has to be specially designed. In a paper published in 2000 (Inorganic Chemistry, 2000, 39(15), page 3301-3311), two organic molecules which comprise carboxylic acid group and water soluble heterocyclic groups (pyrrolidone and imidazole) are used to give organic molecule silver salts. Combining water soluble part and silver containing functional group in one molecule can give organic silver salt with good water solubility.

All the antimicrobial silver salts and antimicrobial organic silver complex mentioned above are still small molecule. They have all the drawbacks of antimicrobial small molecule. In order to combined the good antimicrobial property of silver ion and the benefit of polymer, the development of water soluble antimicrobial polymeric silver salt is very necessary.

Silver ion can form complex with polymer to form polymeric silver salt. The polymeric silver salt has the same problem of low solubility in water as many small molecule silver salts have. In 1934, British patent GB420533(A) discloses the preparation method of silver polyacrylic acid, Although the raw material, sodium polyacrylic acid, is soluble in water, yet the silver polyacrylic acid produced cannot be dissolved in water. The objective of GB420533(A) is to use silver polyacrylic acid as a general plastic material instead of antimicrobial polymer.

U.S. Pat. No. 5,709,870 discloses a water soluble silver containing antimicrobial carboxymethylcellulose (CMC). The preparation is done by suspending sodium CMC in water and exchange sodium with silver using silver nitrate. However, the silver content in the polymer is lower than 1%.

In a paper published in 2001 (Pharmaceutical chemistry Journal, 2001, vol. 35, No 5, Page 252-253), a silver containing water soluble antimicrobial polyacrylic acid with chemical structure of (CH2CHCOOH)n-(CH2CHCOOAg)m (n=9000˜40000 and m=100˜3000, the silver content between 4˜10%) is claimed and presented. It is mentioned in the paper that the silver containing polyacrylic acid can be dissolved in water and have good antimicrobial property. However, in that paper, no preparation method is shown. Yet, in Russian patent RU2220982 filed by the same author, the preparation process is disclosed. The process includes steps of first mixing silver nitrate aqueous solution and polyacrylic acid aqueous solution together, stirring for 30 to 60 minutes and then drying at 50° C. to give a grey transparent product. It is obvious that no pure silver containing polyacrylic acid is obtained by the preparation process of the Russian patent. The product obtained is simply a mixture of silver nitrate and polyacrylic acid.

It is well know that among all the water soluble polymer, polyacrylate is the most versatile water soluble polymer. However, until now there is no water soluble antimicrobial polyacrylate silver salt been designed and synthesized.

### SUMMARY OF THE INVENTION

This invention is about a preparation method of a water soluble antimicrobial polyacrylate silver salt. The preparation method of the water soluble antimicrobial polyacrylate silver salt is first done by doing metal ion exchange with silver salt in aqueous solution containing water soluble polyacrylate comprising sodium carboxylic group (—COONa) or potassium carboxylic group (—COOK). The sodium carboxylic group or potassium carboxylic group is changed to silver carboxylic group (—COOAg) in this metal ion exchange process. Then, the sodium salt byproduct produced in the metal ion exchange process is removed by ultrafiltration membrane process to give an aqueous solution of water soluble antimicrobial polyacrylate silver salt with almost no impurities.

### DETAIL DESCRIPTION OF THE INVENTION

Using silver salt to perform metal ion exchange with sodium carboxylic group or potassium carboxylic group to obtain silver carboxylic group has been well known for sometimes EP0710877B1 and EP1069468B1 discloses some organic silver carboxylate compounds produced by metal ion exchange. Most of these organic silver carboxylate compounds are not soluble in water except some compounds with long hydrophilic chain.

This invention uses metal ion exchange with silver nitrate in aqueous solution to exchange the sodium or potassium of water soluble polyacrylate containing sodium carboxylic group (—COONa) or potassium carboxylic group (—COOK) to silver. By partially converting the sodium carboxylic group or potassium carboxylic group of the water soluble polyacrylate to silver carboxylic group (—COOAg), the thus obtained polyacrylate silver salts comprising silver carboxylic group and sodium carboxylic group or silver carboxylic group and potassium carboxylic group will be able to be dissolved in water.

The aqueous solution after performing metal ion exchange contains water soluble antimicrobial polyacrylate salt, sodium nitrate or potassium nitrate and very small amount of possible remaining silver nitrate. The sodium nitrate, potassium nitrate and remaining very small amount of silver nitrate have to be removed in order to get the pure water soluble antimicrobial polyacrylate silver salt. Conventional method of precipitation for polymer purification is not suitable in this case. It is because that the non-solvent for precipitation are worse solvent for the acrylate silver salt and also worse solvent for sodium nitrate and potassium nitrate. Suitable non-solvent for precipitation has to be miscible with water and do not dissolve the polyacrylate silver salt. The suitable non-solvent can be ethanol, ethylene glycol, tetrahydrofuran, acetone, methylethylketone . . . etc. However, these non-solvents are also worse solvent for sodium nitrate and potassium nitrate. So, when doing the precipitation, sodium nitrate or potassium nitrate will be precipitated out along with the polyacrylate silver salt. It is impossible to get pure polyacrylate silver salt using conventional precipitation method before the sodium nitrate or potassium nitrate is removed.

The purification method of this invention for preparing the water soluble antimicrobial polyacrylate silver salt is ultrafiltration. Ultrafiltration is well known for selectively removing impurity by size exclusion. It is a simple and cost effective method to remove the sodium nitrate or potassium nitrate and other small molecule impurities of the aqueous solution of the water soluble antimicrobial polyacrylate silver salt obtained from metal ion exchange process.

After ultrafiltration treatment, the impurities of the aqueous solution of water soluble antimicrobial polyacrylate silver salt has been removed and the polyacrylate silver salt could be obtained by removing the water of the aqueous solution.

The water soluble polyacrylate comprising sodium carboxylic group or potassium acrylic group used in the metal ion exchange step can be sodium salt or potassium salt of polyacrylic acid, sodium salt or potassium salt of polymethacrylic acid, sodium salts or potassium salt of copolymer of acrylic acid and maleic acid, sodium salt or potassium salt of copolymer of methacrylic acid and maleic acid, sodium salt or potassium salt of copolymer of acrylic acid and methacrylic acid, sodium salt or potassium salt of copolymer of acrylic acid and other acrylic monomer or sodium salt or potassium salt of copolymer of methacrylic acid and other acrylic monomer.

The water soluble polyacrylate comprising sodium carboxylic group or potassium acrylic group used in the metal ion exchange step can be obtained by reacting polyacrylate comprising acrylic acid group (—COOH) with sodium hydroxide or potassium hydroxide to partially change the carboxylic acid group to sodium carboxylic group or potassium carboxylic group. The polyacrylate comprising acrylic acid group (—COOH) can be polyacrylic acid, polymethacrylic acid, copolymer of acrylic acid and maleic acid, copolymer of methacrylic acid and maleic acid, copolymer of acrylic acid and methacrylic acid, copolymer of acrylic acid and other acrylic monomer or copolymer of methacrylic acid and other acrylic monomer.

The silver salt used in the metal ion exchange step can be silver nitrate or silver acetate. The reason for using these two silver salts is because of their high solubility in water, more suppliers and lower cost than other silver salts. However, those silver salts with solubility higher than 0.0001 could also be used. It is just that the concentration of the aqueous solution for metal ion exchange has to be adjusted accordingly.

The metal ion exchange process is carried out in aqueous solution. The water soluble polyacrylate comprising sodium carboxylic group or potassium carboxylic group is dissolved in water. The aqueous solution of silver salt is added into the aqueous solution of water soluble polyacrylate with continuous stirring. If the addition speed is too fast during addition of aqueous solution of silver salt, due to the local high concentration of silver salt at the addition site, there might be some white precipitate appeared. However, with continuous stirring, these white precipitate will eventually disappear. The solution will become clear. The maximum amount of silver salt to be added is that at the point when these white precipitate stay undissolved for a certain period of time The solution will show opaque appearance. The maximum molar amount of silver salt is less than the molar amount of sodium carboxylic group or potassium carboxylic group of the water soluble polyacrylate. It means that in order for the polyacrylate silver salt to stay soluble in water, there should be enough sodium carboxylic group or potassium carboxylic group in the polyacrylate silver salt. If the sodium carboxylic group or potassium carboxylic group in the polyacrylate silver salt is not enough, then the polyacrylate silver salt will not be water soluble

Membranes with molecular weight cut off (MWCO) of 1000 to 1000000 could be used for ultrafiltration. The MWCO of the ultrafiltration membrane is better to be at least one order of magnitude smaller than the molecular weight of the water soluble polyacrylate comprising sodium carboxylic group or potassium carboxylic group. Such choose of MWCO can make sure that no polyacrylate silver salt will be removed along with the sodium nitrate during the ultrafiltration process.

The membrane could be sheet membrane or hollow fiber membrane. The module of the ultrafiltration membrane could be plate and frame module, spiral wound module or hollow fiber module

The aqueous solution of polyacrylate silver salt obtained after metal ion exchange step is put into a storage tank. Pure water can be added into the tank to dilute the solution. A pump is used to pump the aqueous solution of polyacrylate silver salt out from the storage tank into the ultrafiltration membrane module through the module inlet. The concentrated retentate solution of polyacrylate silver salt from the outlet of the ultrafiltration membrane module is fed back into the storage tank. The sodium nitrate or potassium nitrate will pass through the membrane to the permeate side and the plyacrylate silver salt will remain in the retentate side. The ultrafiltration process is kept going until the volume of aqueous solution of the polyacrylate silver salt in the storage tank is reduced to certain ratio of its original volume. Pure water is added into the storage tank to dilute the concentrated retentate solution of polyacrylate silver salt. Second ultrafiltration process is then carried out the same way as the first one. Such ultrafiltration operation is done multiple times to remove the sodium salt or potassium salt and other small molecular impurities to give aqueous solution of water soluble antimicrobial polyacrylate silver salt with almost no impurities.

The water of the ultrafiltration treated aqueous solution of water soluble antimicrobial polyacrylate silver salt can be removed to obtain pure water soluble antimicrobial polyacrylate silver salt. This could be done by conventional water removing process such as evaporation, evaporation at reduced pressure and spray drying. Water can also be removed by pouring the purified and concentrated aqueous solution of the polyacrylate silver salt into a non-solvent (such as ethanol or acetone). The precipitate is collected and dried to give the water soluble antimicrobial polyacrylate silver salt.

### Determination of Metal Ion Exchange Ratio.

500 cc pure water was put into a 1 liter flask with magnetic stirrer. 0.5 g of sodium salt of polyacrylic acid (molecular weight >8,000,000) was added into the flask. Stirring was started to dissolve the sodium salt of polyacrylic acid. The temperature of the solution was kept at 40° C. 1 g of 10% silver nitrate aqueous solution was added into the aqueous solution with continuous stirring. After 30 minutes, appearance of the aqueous solution was observed and recorded. Another 1 g of 10% silver nitrate was then added. After another 30 minutes, appearance of the aqueous solution was observed and recorded. Totally, 10 parts of 1 g of 10% silver nitrate were added into the aqueous solution. The 10 observation results of the appearance of the aqueous solution were shown at the following table.

TABLE 1

| Number of addition of 1 g of | | | | | | | | | | |
|---|---|---|---|---|---|---|---|---|---|---|
| 10% AgNO3 aqueous solution | 1 | 2 | 3 | 4 | 5 | 6 | 7 | 8 | 9 | 10 |
| Appearance of aqeuous solution | clear | clear | clear | clear | clear | clear | opaque | opaque | opaque | opaque |
| of polyacrylic acid silver salt | | | | | | | | | | |
| Molar ratio of —COOAg/ | 0.111 | 0.221 | 0.332 | 0.443 | 0.554 | 0.664 | 0.775 | 0.886 | 0.996 | 1.000 |
| (—COOAg + —COONa) | | | | | | | | | | |
| in polyacrylic acid silver salt | | | | | | | | | | |
| Weight percentage(%) of silver | 11.5 | 21.2 | 29.3 | 36.3 | 42.3 | 47.6 | 52.3 | 56.5 | 60.2 | 60.2 |
| in polyacrylic acid silver salt | | | | | | | | | | |

From the table, it can be seen that when the molar ratio of —COOAg/(—COOAg+—COONa) is greater than 0.77, the polyacrylic acid silver salt obtained will not be soluble in water. In order to give water soluble polyacrylic acid silver salt, the molar ratio of —COOAg/(—COOAg+—COONa) of polyacrylic acid silver salt should be lower than 0.66 or the weight ratio of silver of polyacrylic acid should be lower than 47%.

### EXAMPLE

### Preparation of Water Soluble Polyacrylic Acid Silver Salt

10 g of sodium salt of polyacrylic acid was added into 2 liter pure water. High speed motor was used to dissolve the sodium salt of polyacrylic acid. The stirring speed was 10,000 rpm. The temperature was maintained at 40° C. A very viscous gel like transparent liquid was obtained after stirring for 3 minutes. 10 g of 50% silver nitrate aqueous solution was equally divided into 5 parts and added into the gel like liquid every 30 seconds under high speed stirring. After addition, the high speed stirring was continue for 5 minutes. The viscosity of the gel like liquid was greatly reduced. An aqueous solution of polyacrylic acid silver salt was obtained.

The aqueous solution of polyacrylic acid salt was diluted to 10 liters with pure water. A spiral wounded ultrafiltration module with diameter of 3 inches and length of 10 inches was used. The molecular weight cut off of this ultrafiltration module is 100,000. The volume of the diluted aqueous solution of polyacrylic acid silver salt was reduced to 1 liter. About 9 liters of permeate solution was collected. Sodium chloride was added into 100 cc of the permeate solution. No silver chloride white precipitate was found. It means that almost all the silver ion of silver nitrate added had been exchanged with sodium ion of the sodium salt of polyacrylic acid to give polyacrylic silver salt. All the polyacrylic acid silver salt obtained remained at the concentrated retentate solution.

The 1 liter concentrated retentate solution was diluted to 10 liters with pure water. The 10 liters of diluted solution was reduced to 1 liter by ultrafiltration again. Another dilution and ultrafiltration was done to give 1 liter of purified aqueous solution of polyacrylic acid silver salt with very few impurities. 10 cc of the concentrated retentate solution of polyacrylic acid silver salt was added into 1 liter of acetone. The precipitate was collected and dried to give purified polyacrylic acid silver salt. The polyacrylic acid silver salt can be dissolved into water again to give aqueous solution of the polyacrylic acid silver salt.

### Antimicrobial Testing

An aqueous solution of polyacrylic acid silver salt obtained from the example above was prepared. The silver content of the aqueous solution was adjusted to 100 ppm. Two pieces of 1 cm² toasts were prepared. One was thoroughly wetted by spraying the aqueous solution of polyacrylic acid silver salt onto the toast. The other was also thoroughly wetted by spraying pure water onto the toast. These two pieces of wet toasts were stored in a humid environment at 30° C. The change of the toasts were observed and recorded every day. The results were shown at the following table.

TABLE 2

| | Observation Results | | | | | | |
|---|---|---|---|---|---|---|---|
| Day of experiment | day 1 | day 2 | day 3 | day 4 | day 5 | day 6 | day 7 |
| toast wetted with aqeous solution | no mold | no mold | no mold | no mold | no mold | no mold | no mold |
| of polyacrylic acid silver salt | | | | | | | |
| toast weetted with water | no mold | mold | mold | mold | mold | mold | mold |

It can be seen from the table above that the antimicrobial performance of the polyacrylic acid silver salt is very good. The toast wetted by aqueous solution of polyacrylic acid silver salt with silver content of 100 ppm showed no mold after staying at humid environment at 30° C. for 7 days.

1. A preparation method of water soluble antimicrobial polyacrylate silver salt comprises four steps, a first step of dissolving a water soluble polyacrylate comprising sodium carboxylic group or potassium carboxylic group in water, a second step of carrying out metal ion exchange process by adding silver salt to the aqueous solution of water soluble polyacrylate comprising sodium carboxylic group or potassium carboxylic group to give aqueous solution of water soluble polyacrylate silver salt, a third step of using ultrafiltration membrane process to remove the sodium salt or potassium salt produced in second step from the aqueous solution of water soluble polyacrylate silver salt and a forth step of removing the water from the aqueous solution of water soluble polyacrylate silver salt to give water soluble antimicrobial polyacrylate silver salt.

2. The method of claim 1, wherein said water soluble polyacrylate comprising sodium carboxylic group or potassium carboxylic group is selected from the group consisting of sodium plyacrylic acid, potassium polyacrylic acid, sodium polymethacrylic acid, potassium polymethacrylic acid, sodium salts or potassium salt of copolymer of acrylic acid and maleic acid, sodium salt or potassium salt of copolymer of methacrylic acid and maleic acid, copolymer of sodium acrylate and other acrylic monomer, copolymer of potassium acrylate and other acrylic monomer, copolymer of sodium methacrylate and other acrylic monomer and copolymer of potassium methacrylate and other acrylic monomer.

3. The method of claim 1, wherein said silver salt is silver salt with solubility in water higher than 0.0001.

4. The method of claim 1, wherein said silver salt is silver nitrate or silver acetate.

5. The method of claim 1, wherein said ultrafiltration membrane is flat sheet membrane or hollow fiber membrane.

6. A preparation method of aqueous solution of water soluble antimicrobial polyacrylate silver salt comprises three steps, a first step of dissolving a water soluble polyacrylate comprising sodium carboxylic group or potassium carboxylic group in water, a second step of carrying out metal ion exchange process by adding silver salt to the aqueous solution of water soluble polyacrylate comprising sodium carboxylic group or potassium carboxylic group and a third step of using ultrafiltration membrane process to remove the sodium salt or potassium salt produced in metal ion exchange process to give the aqueous solution of water soluble polyacrylate silver salt.

7. The method of claim 6, wherein said water soluble polyacrylate comprising sodium carboxylic group or potassium carboxylic group is selected from the group consisting of sodium plyacrylic acid, potassium polyacrylic acid, sodium polymethacrylic acid, potassium polymethacrylic acid, sodium salts or potassium salt of copolymer of acrylic acid and maleic acid, sodium salt or potassium salt of copolymer of methacrylic acid and maleic acid, copolymer of sodium acrylate and other acrylic monomer, copolymer of potassium acrylate and other acrylic monomer, copolymer of sodium methacrylate and other acrylic monomer and copolymer of potassium methacrylate and other acrylic monomer.

8. The method of claim 6, wherein said silver salt is silver salt with water solubility higher than 0.0001.

9. The method of claim 6, wherein said silver salt is silver nitrate or silver acetate.

10. The method of claim 6, wherein said ultrafiltration membrane is flat sheet membrane or hollow fiber membrane.
